(19) United States
(12) Patent Application Publication
(10) Pub. No.: US 2026/0187421 A1
(43) Pub. Date: Jul. 2, 2026

(54) USER CLUSTERING AND PROMPT GENERATION TOOLS FOR REFINING OUTPUTS OF LANGUAGE MODELS

(71) Applicant: Google LLC, Mountain View, CA (US)

(72) Inventors: Jason Sean Krueger, Seattle, WA (US); Nicholas James Reid, Seattle, WA (US)

(21) Appl. No.: 18/858,837

(22) PCT Filed: Jul. 19, 2023
(86) PCT No.: PCT/US2023/028155

§ 371 Date: Oct. 22, 2024

(51) Int. Cl. G06N 3/0475; G06F 18/2321

(52) U.S. Cl. CPC G06N 3/0475; G06F 18/2321

(57) ABSTRACT

One example method includes identifying, by an artificial intelligence (AI) system and based on interactions with a user about a particular item, a first cluster from among a plurality of clusters, wherein each of the plurality of clusters indicates one or more preferences about the particular item corresponding to users in the cluster. The AI system can generate a prompt that includes a query and a set of constraints that limit customized recommendations generated by a language model, wherein the set of constraints includes one or more first preferences corresponding to the first cluster. The AI system can generate, using the prompt, a customized recommendation for the user about the particular item.

### BACKGROUND

This specification relates to data processing and refining outputs of language models based on identifying users'preferences.

Advances in machine learning are enabling artificial intelligence to be implemented in more applications. For example, large language models have been implemented to allow for a conversational interaction with computers using natural language rather than a restricted set of prompts. This allows for a more natural interaction with the computer.

### SUMMARY

In general, one innovative aspect of the subject matter described in this specification can be embodied in methods that include the actions of identifying, by an artificial intelligence (AI) system and based on interactions with a user about a particular item, a first cluster from among a plurality of clusters, wherein each of the plurality of clusters indicates one or more preferences about the particular item corresponding to users in the cluster; generating, by the AI system, a prompt that includes a query and a set of constraints that limit customized recommendations generated by a language model, wherein the set of constraints includes one or more first preferences corresponding to the first cluster; and generating, by the AI system and using the prompt, a customized recommendation for the user about the particular item.

These and other embodiments can each optionally include one or more of the following features. Generating the prompt can include inserting at least a part of the one or more first preferences into the prompt as a contextual constraint that limits the customized recommendations created by the language model to subject matter specified in the contextual constraint.

Identifying the first cluster can include generating, by the AI system, one or more questions about preferences of the user for the particular item; receiving, by the AI system, one or more responses to the one or more questions; and identifying, by the AI system and based on the one or more responses, the first cluster.

Identifying, by the AI system and based on the one or more responses, the first cluster can include embedding the one or more responses in a multi-dimensional semantic space, wherein each of the plurality of clusters is associated with corresponding sample responses embedded in the multi-dimensional semantic space; determining a distance between (i) the one or more responses and (ii) sample responses of each cluster of the plurality of clusters; and identifying the first cluster having the smallest distance among the plurality of clusters.

Identifying, by the AI system and based on the one or more responses, the first cluster can include inputting the one or more responses to a machine learning model to determine the first cluster.

Identifying the first cluster can include obtaining, by the AI system, one or more images depicting one or more items possessed by the user; performing, by the AI system, image recognition on the one or more images to identify the one or more items; and identifying, by the AI system and based on the one or more items, the first cluster.

Identifying, by the AI system and based on the one or more items, the first cluster can include obtaining, by the AI system, user input associated with the one or more items, the user input indicating whether the user characterizes each of the one or more items as positive or negative; and identifying, by the AI system and based on the user input, the first cluster.

Identifying, by the AI system and based on the user input, the first cluster can include determining a distance between (i) the user input and (ii) sample user inputs of each cluster of the plurality of clusters; and identifying the first cluster having the smallest distance among the plurality of clusters.

Identifying, by the AI system and based on the user input, the first cluster can include inputting the user input to a machine learning model to determine the first cluster.

Identifying the first cluster can include obtaining, by the AI system, user utilization associated with one or more items possessed by the user, the user utilization indicating a frequency of use for each of the one or more items; determining, based on the user utilization, one or more item preferences of the user for the one or more items, wherein a higher user utilization for an item indicates a higher item preference for the item; and identifying, by the AI system and based on the one or more item preferences, the first cluster.

Identifying, by the AI system and based on the one or more item preferences, the first cluster can include determining a distance between (i) the one or more item preferences and (ii) sample item preferences of each cluster of the plurality of clusters; and identifying the first cluster having the smallest distance among the plurality of clusters.

Identifying, by the AI system and based on the one or more item preferences, the first cluster can include inputting the one or more item preferences to a machine learning model to determine the first cluster.

Determining, based on the user utilization, one or more item preferences of the user for the one or more items can include determining whether a first user utilization associated with a first item satisfies a predetermined threshold; and in response to determining that the first user utilization satisfies the predetermined threshold, determining that a first item preference for the first item is high; or in response to determining that the first user utilization does not satisfy the predetermined threshold, determining that a first item preference for the first item is low.

Identifying the first cluster can include obtaining, by the AI system, contents from one or more social network accounts associated with the user; and identifying, by the AI system and based on the obtained contents, the first cluster.

The obtained contents can indicate whether the user characterizes each of one or more items as positive or negative, and the methods can include performing sentiment analysis on the obtained contents to generate one or more item preferences of the user for the one or more items; and inputting the one or more item preferences to a machine learning model to determine the first cluster.

The one or more preferences about the particular item can include at least one of a budget level for acquiring the particular item, a quality level of the particular item, one or more preferred features of the particular item, or a preferred amount of time for researching the particular item.

Generating, by the AI system and using the prompt, the customized recommendation for the user about the particular item can include generating, using the query and the set of constraints, a plurality of clauses; and generating, based on the plurality of clauses, the customized recommendation.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which refining outputs of language models can be performed, according to an implementation of the present disclosure.

FIG. 2 is a block diagram illustrating interactions between an artificial intelligence system, a language model, and a client device, according to an implementation of the present disclosure.

FIG. 3 is a flow chart of an example process for refining outputs of language models, according to an implementation of the present disclosure.

FIG. 4 is a block diagram of an example computer system that can be used to perform described operations, according to an implementation of the present disclosure.

Like reference numbers and designations in the various drawings indicate like elements.

### DETAILED DESCRIPTION

This specification describes techniques for refining outputs of language models based on identifying users'preferences, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Artificial intelligence (AI) is a segment of computer science that focuses on the creation of intelligent agents that can learn and act autonomously (e.g., without human intervention). AI can utilize machine learning, which focuses on developing algorithms that can learn from data; natural language processing, which focuses on understanding and generating human language; and/or computer vision, which is a field that focuses on understanding and interpreting images and videos period.

The techniques described throughout this specification enable AI to generate a customized recommendation for a user about an item based on identifying preference(s) of the user about the item. For example, an AI system can gather information about the preference(s) of the user from various sources, such as the user's responses to AI's generated questions (e.g., viewing on and using a graphical user interface (GUI)), image(s) depicting item(s) possessed by the user (e.g., using an image capture device on a mobile device), the utilization associated with item(s) possessed by the user, and content from social network account(s) associated with the user. Based on the information about the preference(s) of the user, the AI system can identify a cluster for the user from among a plurality of clusters, where each cluster of the plurality of clusters indicates one or more preferences about the item corresponding to users in the cluster. The AI system can generate a prompt including preference(s) corresponding to the identified cluster. The preference(s) corresponding to the identified cluster can limit customized recommendations generated by a language model.

As discussed in more detail below, the preference(s) of the user about the item can be used to specialize (e.g., to create or to augment) the prompt(s) to improve overall quality of the customized recommendations generated about the item. Post-processing operations can then be used to evaluate the generated candidate customized recommendations against each other to determine which candidate customized recommendations have higher quality than other candidate customized recommendations (e.g., given the current context), and one or more of the higher-quality customized recommendations are output to a computing device (e.g., laptop/desktop computer, mobile device, tablet device, audio device, or gaming device).

Using the specialized prompt reduces wasted computing resources that would otherwise generate more low-quality recommendations if using a more generalized prompt. Similarly, as discussed in more detail below, a number of candidate customized recommendations generated can be reduced, thereby saving computing resources and generating faster output(s), by using the specialized prompt to constrain the parameters used by the language model to generate the candidate customized recommendations. For example, by constructing the prompt to limit types of content that can be included in generated candidate customized recommendations, the language model will not generate candidate customized recommendations that violate the constraints of the prompt, thereby avoiding the creation of unwanted candidate customized recommendations, which reduces the time required to generate the candidate customized recommendations, the memory required to store the candidate customized recommendations, and the computing resources required to generate and evaluate the candidate customized recommendations. This all contributes to a system capable of quickly creating new recommendations, such that the new recommendations can be created and served in a real-time interactive environment e.g., in response to a user query.

The post-processing operations can include, for example, evaluating the candidate customized recommendations based on various criteria, and scoring each of the candidate customized recommendations based on the evaluation. For example, one post-processing operation can perform a prediction regarding a likelihood that a particular candidate customized recommendation is ungrounded (e.g., includes information that cannot be verified in a specified corpus). Using this type of a post-processing operation allows for looser constraints in the construction of the specialized prompt, which can allow the language model to generate more creative candidate customized recommendations, while still ensuring that the output customized recommendation has at least a baseline level of truthfulness. The post-processing operations can also use various heuristics to evaluate different characteristics of each of the candidate customized recommendations, and the scores can be assigned based on the various heuristics. In some implementations, the scores are weighted and aggregated to create a final score, which is used to rank the candidate customized recommendations. Additionally, or alternatively, a machine learning model can be trained to score customized recommendation quality, and those scores can be used to rank the candidate customized recommendations. One or more of the highest ranking candidate customized recommendations are then selected for serving as output customized recommendations.

In some implementations, the techniques described herein can be used in the context of making recommendations. In one example use case, the techniques described herein can be used to implement an AI personal shopper that can make shopping recommendations customized for a user. For example, in some implementations, a user can transmit a query to an AI system about a particular item (e.g., an item that the user is interested in acquiring). The AI system can identify, from a plurality of clusters, a cluster that the user falls in, where the cluster can indicate the user's preference(s) about the item and/or the AI shopper. For example, in some cases, the identified cluster can be used to determine a persona of the AI shopper, where the persona can affect, for example, an amount of information in the recommendations provided to the user (e.g., detailed, concise, etc.), a formatting style based on the user's preference(s), and so on.

As noted, in some cases, to identify the cluster, the AI system can obtain information about the preference(s) of the user from various sources. For example, in the example use case of an AI personal shopper, the AI system can determine the user's preference(s) based on the items the user possesse(s/d) and/or the utilization of those items. For example, if the user indicates a preference for a particular item they possess and/or utilizes the particular item very often, the AI system can infer that the user prefers items having similar features as the particular item. The AI system can then recommend such items for the user to shop for.

In some cases, the AI system can generate customized recommendations by analyzing the items associated with the user's connections, such as possessions, reviews, recommendations, and more. These connections can include family members, friends, or contacts from the user's social network(s). Generating customized recommendations based on the user's trusted connections can enhance the credibility of the customized recommendations.

Additionally, in some cases, the AI system can generate customized recommendations for the user to obtain a particular item for one of their connections. By obtaining the preferences of the user's connection, the AI system can create a customized recommendation for the user based on those preferences. For instance, if the user wants gift ideas for sending a present to their connection, they can request suggestions from the AI system, which can generate the customized recommendations based on the preferences of the user's connection.

One skilled in the art will appreciate that the techniques described herein are not limited to just these applications but can be applicable in other contexts.

As used throughout this document, the phrase “digital component” refers to a discrete unit of digital content or digital information (e.g., a video clip, audio clip, multimedia clip, gaming content, image, text, bullet point, AI output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component. In some cases, the digital component can be a customized recommendation for a user about a particular item (e.g., a recommendation of a product of the particular item that the user may like).

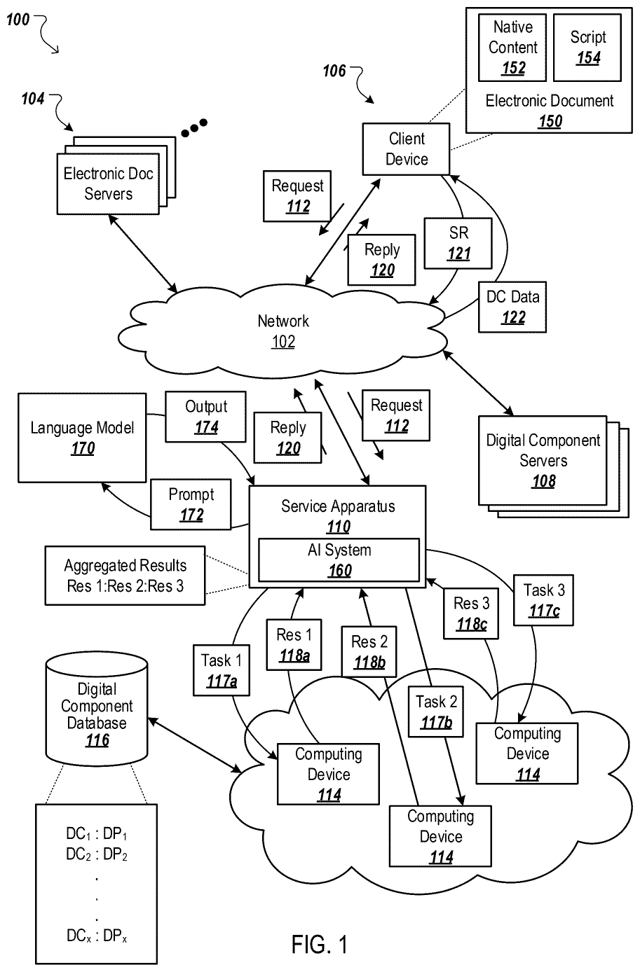

FIG. 1 is a block diagram of an example environment 100 in which refining outputs of language models can be performed, according to an implementation of the present disclosure. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., a Uniform Resource Locator (URL)) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an AI system 160 configured to autonomously generate digital components, either prior to a request 112 (e.g., offline) and/or in response to a request 112 (e.g., online or real-time). As described in more detail throughout this specification, the AI system 160 can collect online content about a specific entity (e.g., digital component provider or another entity) and summarize the collected online content using one or more language models 170, which can include large language models.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CORR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

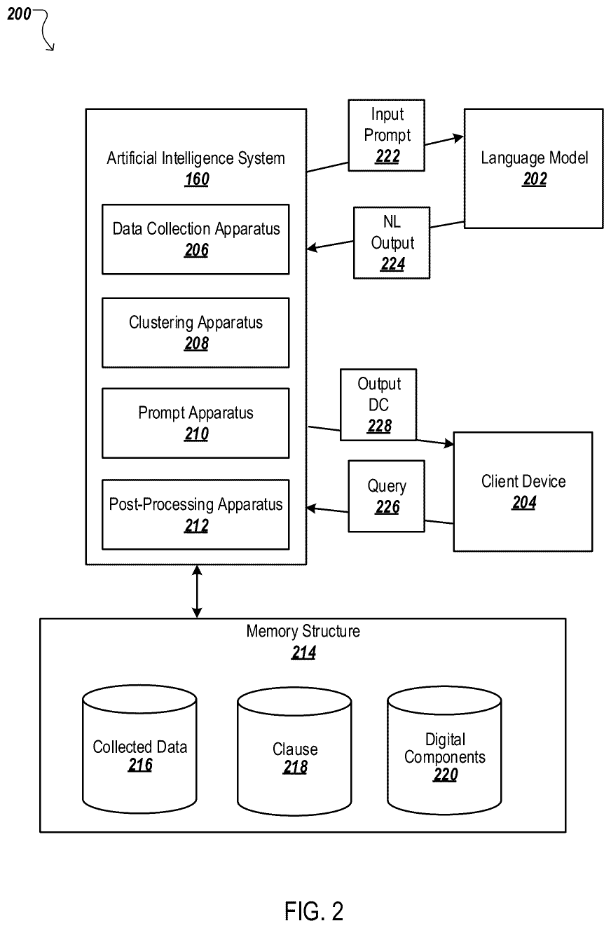

FIG. 2 is a block diagram 200 illustrating interactions between an AI system, a language model, and a client device, according to an implementation of the present disclosure. In some situations, the language model 202 and client device 204 can, respectively, be the same or similar to the language model 170 and client device 106 of FIG. 1. Although a single language model 202 is depicted in FIG. 2, the language model 202 can be a set of different language models that can be invoked for different tasks for which the different language models are specially trained. For example, one language model within the set of language models may be specially trained to interact with users about items, while another model may be specially trained to generate customized recommendations for items, for example, using the output of the specially trained language model for user interactions. Furthermore, the set of models can include a generalized language model that is larger is size, and capable of generating large amounts of diverse datasets, but this generalized model may have higher latency than the specialized models, which can make it less desirable for use in real-time operations, depending on time latency constraints required to generate content.

The AI system 160 includes a data collection apparatus 206, a clustering apparatus 208, a prompt apparatus 210, and a post-processing apparatus 212. The following description refers to these different apparatuses as being implemented independently and each configured to perform a set of operations, but any of these apparatuses could be combined to perform the operations discussed below.

At a high level, the client device 204 transmits a query 226 to the AI system 160. In some cases, the query 226 can be a request for the AI system 160 to generate a recommendation for a particular item (e.g., a recommendation for a product of the particular item that the user may like). The data collection apparatus 206 collects information about the preference(s) of the user from various sources, such as the user's responses to questions generated by the AI system 160, image(s) depicting item(s) possessed by the user, the utilization associated with item(s) possessed by the user, contents from social network account(s) associated with the user, etc. Based on the information collected by the data collection apparatus 206, the clustering apparatus 208 can identify a cluster for the user from among a plurality of clusters, where each of the plurality of clusters indicates one or more preferences about the particular item corresponding to users in the cluster. The prompt apparatus 210 can generate an input prompt 222 that includes a set of constraints including, for example, one or more of the preference(s) about the particular item corresponding to users in the identified cluster. The AI system 160 can transmit the input prompt 222 to the language model 202, which can then generate natural language (NL) output 224 (e.g., clauses or phrases) limited by the set of constraints in the input prompt 222. The post-processing apparatus 212 can process the NL output 224 to generate output digital components 228 (e.g., customized recommendations) and transmit the output digital components to the client device 204. More details are described below.

The AI system 160 is in communication with a memory structure 214. The memory structure 214, can include one or more databases. As shown, the memory structure includes a collected data database 216, a clause database 218, and a digital components database 220. Each of these databases 216, 218, and 220, can be implemented in a same hardware memory device, separate hardware memory devices, and/or implemented in a distributed cloud computing environment.

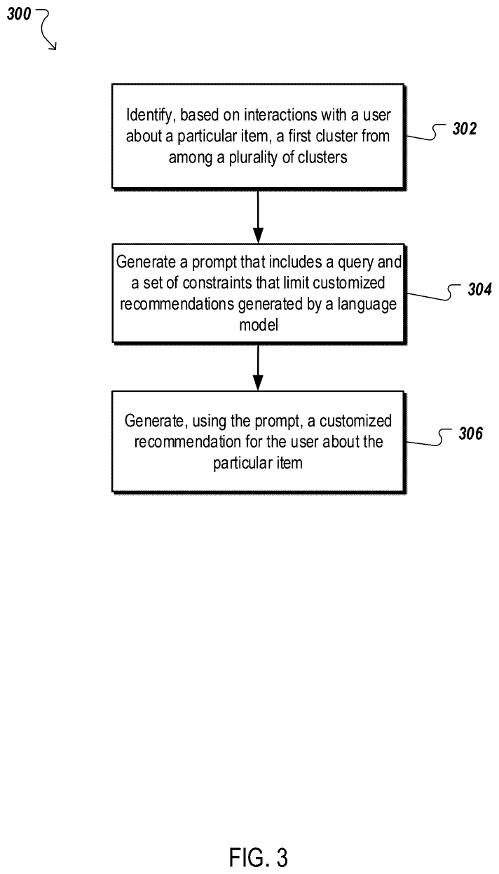

The data collection apparatus 206 is implemented using at least one computing device (e.g., one or more processors), and can include one or more language models. The data collection apparatus 206 is configured to collect, for example, information about the preference(s) of the user (more details are described with respect to FIG. 3). In some implementations, the collected information includes, for example, user's responses to questions generated by the AI system 160, image(s) depicting item(s) possessed by the user, the utilization associated with item(s) possessed by the user, and/or contents from social network account(s) associated with the user.

The data collection apparatus 206 can store the collected data in the collected data database 216. For example, the data collection apparatus 206 can index the collected data to the query used to collect the data and/or an entity characterized by the collected data so that the collected data can be retrieved from the collected data database 216 for additional operations performed by the data collection apparatus 206 and/or any operations performed by the AI system 160.

The clustering apparatus 208 is implemented using at least one computing device (e.g., a device including one or more processors), and can include one or more machine learning models. The clustering apparatus 208 is configured to identify a cluster from among a plurality of clusters for a user based on information about the preference(s) of the user collected by the data collection apparatus 206 (more details are described with respect to FIG. 3). Each of the plurality of clusters can indicate one or more preferences corresponding to users in the cluster.

The preference(s) corresponding to the identified cluster can be provided to a prompt apparatus 210, which is implemented using at least one computing device (e.g., a device including one or more processors), and can include one or more language models. The prompt apparatus 208 is configured to generate a prompt that includes a query 226, and a set of constraints (more details are described with respect to FIG. 3).

The query 226 can be received, for example, from a client device 204. The query 226 can be input through a search service, a chat interface, a gaming interface, a digital assistant interface, or another interface to a service provided either online, or through a native application installed at the client device. The query 226 can be as simple as a single token, or can be a series of tokens that constitute a multi-token phrase. In this scenario, the query 226 is received by the AI system 160, and can be inserted into the prompt by the prompt apparatus 210. Additionally, or alternatively, the AI system 160 can use the query 226 to search for, or otherwise obtain, information related to the query 226. For example, the AI system 160 can use the query 226 to identify relevant information in the stored collected data database 216, collect data relevant to the query 226 from various online locations, as described above with reference to the data collection apparatus 206, or otherwise use the query 226 to generate or identify information that can provide additional context for creation of the prompt (e.g., collect location data related to the query, etc.).

The set of constraints can include preference(s) corresponding to the identified cluster, which can be obtained based on information about the user (e.g., as described above with reference to the data collection apparatus 206). For example, the prompt apparatus 210 can insert, into the prompt, one or more of the preference(s) corresponding to the identified cluster as identified by the clustering apparatus 208. In some implementations, the one or more of the preference(s) corresponding to the identified cluster inserted into the prompt operates as a contextual constraint that limits content created by the language model 202 responsive to the prompt that contains the preference(s). For example, the preference(s) can limit the content created by the language model to subject matter specified by the preference(s) that is included in the prompt as a contextual constraint, as described in more detail below.

As noted, the AI system can transmit the input prompt 222 to the language model 202, which can then generate NL output 224 (e.g., clauses) based on the input prompt 222. The clauses obtained from the language model 202 can be stored in a clause database 218 for further processing by the post processing apparatus 212.

The post-processing apparatus 212 of the AI system 160 is implemented using at least one computing device (e.g., a device including one or more processors), and can include one or more language models. The post-processing apparatus 212 is configured to (e.g., specially programmed with software) perform one or more post-processing operations on candidate digital components (more details are described with respect to FIG. 3). In some implementations, the post-processing operations can occur after the digital components have been constructed (e.g., clauses, links, and/or other objects are combined into a candidate digital component). In some implementations, the post-processing operations can be performed before completing construction of the candidate digital components. For example, one or more of the post-processing operations can be performed on the clauses in the NL output 224 of the language model 202 before they are combined with a link to create a completed candidate digital component. As used throughout this specification, performing post-processing operations on the clauses prior to combination into a completed candidate digital component is considered performance of the post-processing on a candidate digital component unless otherwise stated.

In some implementations, the output digital components 228 can be generated in an offline process (e.g., prior to receipt of the query 226), and stored in a digital components database 220 until receipt of the query 226. At that time, one or more of the output digital components 228 can be retrieved from the digital components database 220, and served to the client device 204.

FIG. 3 is a flow chart of an example process 300 for refining outputs of language models, according to an implementation of the present disclosure. Operations of the process 300 can be performed, for example, by the service apparatus 110 of FIG. 1, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300.

At 302, an AI system (e.g., the AI system 160) identifies, based on interactions with a user about a particular item, a first cluster from among a plurality of clusters, where each of the plurality of clusters indicates one or more preferences about the particular item corresponding to users in the cluster. The operation 203 can be performed by, for example, the clustering apparatus 208. The particular item can be, for example, a product, a service, a digital content, etc., that the user is interested in acquiring. In some cases, the one or more preferences about the particular item include at least one of a budget level for acquiring the particular item, a quality level of the particular item, one or more preferred features of the particular item, or a preferred amount of time for researching the particular item. For example, the users of a cluster can be budget-sensitive and do not want to spend much time researching the particular items to acquire, whereas the users of another cluster prefer high-quality items and are willing to spend time researching the features of the items to acquire.

In some cases, before identifying the first cluster for the user, the AI system receives a query for the particular item. For example, the user can input a prompt to request the AI system to generate a recommendation for the particular item (e.g., a recommendation for a product of the particular item that the user may like). As an example, the particular item can be trekking poles, and the user can input a prompt to request the AI system to recommend a manufacturer and/or a model of trekking poles that the user may like.

To identify the first cluster, in some instances, the AI system generates one or more questions about preferences of the user for the particular item. The AI system can receive one or more responses to the one or more questions, and identify, based on the one or more responses, the first cluster. In some cases, the question(s) can relate to, for example, a budget level for acquiring the particular item, a quality level of the particular item, one or more preferred features of the particular item, or a preferred amount of time for researching the particular item.

In some implementations, the AI system can identify the first cluster by embedding the one or more responses in a multi-dimensional semantic space, where each of the plurality of clusters is associated with corresponding sample responses embedded in the multi-dimensional semantic space. In some cases, each cluster's sample responses can correspond to one or more points in the multi-dimensional semantic space, and the one or more points can represent the center of the cluster in the multi-dimensional semantic space. Accordingly, distance(s) between the response(s) (input by the user) and the sample responses of a cluster can represent a similarity of the user and other users in the cluster. So, for example, a small distance indicates a high similarity of the user and other users in the cluster, whereas a large distance indicates a low similarity of the user and other users in the cluster. Therefore, to identify the first cluster for the user, the AI system can determine a distance between (i) the one or more responses and (ii) sample responses of each cluster of the plurality of clusters. The AI system can identify the first cluster based on the determined distances. For example, the first cluster can be the one that has the smallest distance among the plurality of clusters.

In some implementations, the AI system identifies, based on the one or more responses, the first cluster by inputting the one or more responses to a machine learning model to determine the first cluster. In some cases, the machine learning model can be trained using a set of training data and a corresponding set of labels, where the training data can include multiple sets of data relating to multiple users and responses provided by the multiple users. For example, a piece of training data can include user responses to questions about preferences of the user for an item. The label of the piece of training data can be, for example, a cluster identified for the user. The machine learning model can be trained by optimizing a loss function based on a difference between the model's output during training and the corresponding label.

In some instances, the AI system identifies the first cluster based on one or more items possessed by the user. In some implementations, the AI system can obtain one or more images depicting one or more items possessed by the user. The one or more images can be, for example, photo(s), video clip(s), etc., captured by camera(s) of a client device (e.g., the client device 106). The AI system can perform image recognition on the one or more images to identify the one or more items. In some cases, the AI system can use the image(s) to collect data about the items(s) depicted in the image(s). For example, the AI system can search the Internet to identify an item matching the item depicted in the image(s) and collect data associated with the item, such as the brand, manufacturer, model, features, prices, reviews, etc., for the item.

In some implementations, the items are not limited to those currently possessed by the user, but can include the items the user has owned and/or the items the user may want in the future. In some cases, the AI system allows the user to enter the items the user has owned and/or the items the user may want in the future. In some cases, the AI system can automatically identify these items. For example, the AI system can identify the items the user has owned via order history in one or more of the user's online accounts (e.g., Amazon. com, Walmart. com, etc.). For another example, the AI system can identify the items the user may want in the future by analyzing the user's online browsing history and/or the user's wish list(s) in one or more of the user's online accounts.

The AI system can identify the first cluster based on user input about the item(s) and/or collected data about the item(s). In some cases, the user can provide user input associated with the item(s), the user input indicating whether the user characterizes each of the item(s) as positive or negative. The user input can be, for example, a flag or indicator (e.g., 0 or 1) indicating whether the user likes the item or not. In some cases, the user input can include information such as particular features of an item the user likes/dislikes, the frequency of use for an item (e.g., frequent, sometimes, seldom, etc.), etc. In some implementations, the AI system can generate questions about the user input and transmit the questions to the client device. For example, assuming that the user input indicates that the user likes an item, the AI system can generate a question asking about the specific feature(s) the user likes. For another example, the AI system can recommend related item(s) that are different from the item possessed by the user and ask the user to confirm whether the user also likes the recommended item(s).

In some cases, the AI system can use the user input and/or collected data to identify the first cluster using similar operations described above with respect to identifying the first cluster based on the multi-dimensional semantic space. For example, the AI system can identify the first cluster by embedding the user input and/or collected data in the multi-dimensional semantic space, where each of the plurality of clusters is associated with corresponding sample user input and/or sample data associated with the item(s) embedded in the multi-dimensional semantic space. The AI system can determine distance(s) between (i) the user input and/or collected data and (ii) sample user input and/or sample data associated with the item(s) of each cluster of the plurality of clusters. The AI system can identify the first cluster based on the determined distances. For example, the first cluster can be the one that has the smallest distance among the plurality of clusters.

In some examples, the AI system inputs the user input and/or collected data about the item(s) possessed by the user to a machine learning model to determine the first cluster. In some cases, the machine learning model can be trained using a set of training data and a corresponding set of labels, where the training data can include multiple sets of data relating to multiple items possessed by multiple users. For example, a piece of training data can include user input and/or collected data about the item(s) possessed by a user. The label of the piece of training data can be, for example, a cluster identified for the user. The machine learning model can be trained by optimizing a loss function based on a difference between the model's output during training and the corresponding label.

In some cases, the AI system can identify the first cluster based on user utilization of the item(s) possessed by the user, where the user utilization indicates a frequency of use for each of the item(s). In some implementations, the AI system can obtain user utilization associated with one or more items possessed by the user. The user utilization can indicate, for example, the number of times the user uses an item each week, month, year, etc. In some cases, the user utilization can be entered by the user. In some cases, the user utilization can be collected using a sensor (e.g., radio frequency identification (RFID)) in the item. In some implementations, the AI system can transmit, based on context data (e.g., weather data, location data, calendar data, etc.), a prompt to the client device in response to a certain condition, where the prompt asks the user about a particular item the user possessed. For example, if the weather data and location data indicate that it has rained at the user's location today, the AI system can generate a prompt asking the user whether they have worn their pair of waterproof shoes today. The user utilization can be updated based on the user's responses.

In some implementations, the AI system can determine, based on the user utilization, item preference(s) of the user for the item(s) possessed by the user. The user utilization for an item can positively correlate with the item preference(s) of the user for the item. So, for example, a high user utilization for an item indicates a high item preference for the item, whereas a low user utilization for an item indicates a low item preference for the item. In some examples, the AI system can determine whether a user utilization associated with an item satisfies a predetermined threshold to determine the item preference of the user for the item. For example, when the AI system determines that the user utilization satisfies (e.g., meets or exceeds) the predetermined threshold, the AI system determines that the item preference for the item is high. On the other hand, when the AI system determines that the user utilization does not satisfy (e.g., below) the predetermined threshold, the AI system determines that the item preference for the item is low.

In some cases, the AI system can use the item preference(s) and/or the user utilization of the item(s) possessed by the user to identify the first cluster using similar operations described above with respect to identifying the first cluster based on the multi-dimensional semantic space. For example, the AI system can identify the first cluster by embedding the item preference(s) and/or the user utilization in the multi-dimensional semantic space, where each of the plurality of clusters is associated with corresponding sample item preference(s) and/or sample user utilization embedded in the multi-dimensional semantic space. The AI system can determine distance(s) between (i) the item preference(s) and/or the user utilization and (ii) sample item preference(s) and/or sample user utilization of each cluster of the plurality of clusters. The AI system can identify the first cluster based on the determined distances. For example, the first cluster can be the one that has the smallest distance among the plurality of clusters.

In some examples, the AI system inputs the item preference(s) and/or the user utilization about the item(s) possessed by the user to a machine learning model to determine the first cluster. In some cases, the machine learning model can be trained using a set of training data and a corresponding set of labels, where the training data can include multiple sets of data relating to multiple items possessed by multiple users. For example, a piece of training data can include item preference(s) and/or the user utilization about the item(s) possessed by a user. The label of the piece of training data can be, for example, a cluster identified for the user. The machine learning model can be trained by optimizing a loss function based on a difference between the model's output during training and the corresponding label.

In some cases, the AI system can identify the first cluster based on contents from social network account(s) associated with the user. In some cases, the user can post contents (e.g., texts, pictures, videos, etc.) about particular item(s) in their social network account(s) (e.g., REDDIT, STRAVA, GARMIN, etc.), and these contents can indicate the user's preference(s) about the particular item(s) or related item(s). In some implementations, the user can allow the AI system to access one or more of the user's social network account(s). The AI system can obtain contents from the social network account(s) and parse the contents to analyze the sentiment(s) of the user for particular item(s). For example, the AI system can perform sentiment analysis on the obtained contents by using a deep language model (e.g., RoBERTa) to identify the user's sentiment(s). The user's sentiment(s) can indicate item preference(s) of the user for certain item(s). For example, if the sentiment analysis indicates that the user is generally positive about a particular item, the AI system can determine that the user prefers the particular item or other similar items. On the other hand, if the sentiment analysis indicates that the user is generally negative about a particular item, the AI system can determine that the user dislikes the particular item or other similar items. In some examples, the AI system can input the item preference(s) to a machine learning model to determine the first cluster using similar operations as described above.

At 304, the AI system generates a prompt (e.g., using the prompt apparatus 210) that includes a query and a set of constraints that limit customized recommendations generated by a language model. In some cases, the set of constraints can include the one or more preferences corresponding to the first cluster. For example, generation of the prompt can include inserting at least a portion of the one or more preferences into the prompt as a contextual constraint that limits the customized recommendations created by the language model to subject matter specified in the contextual constraint.

In some implementations, the AI system can generate a prompt that is submitted to language model(s) (e.g., the language model 170), and causes the language model(s) to generate the output sequences, also referred to simply as “output.” The AI system can generate the prompt in a manner (e.g., having a structure) that specifies a set of constraints the language model(s) must use to generate the output. The AI system can insert at least a portion of the one or more preferences into the prompt that is submitted to the language model as constraint(s) for generating clauses for use in digital components (e.g., customized recommendations) being generated by the AI system. More specifically, assume that the AI system is generating a customized recommendation to provide in response to a request, which includes a keyword/query (e.g., a particular item to acquire). In this example, the AI system can generate the prompt to include the query and a set of constraints including the one or more preferences corresponding to the first cluster as identified in operation 302. In some cases, the set of constraints of the prompt can also include instructions regarding how clauses generated by the language model using the prompt are to be formatted, styled, semantically styled, among other things (e.g., specifying content that should be excluded from the clauses, such as granular details (e.g., numbers)).

For example, if the preference(s) includes a budget range, the generated prompt can include the budget range, so that the customized recommendations generated by a language model include items within the budget range. For another example, if the preference(s) includes particular feature(s) the user prefers, the generated prompt can include the particular feature(s), so that the customized recommendations generated by a language model include items having the particular feature(s).

In some examples, the AI system can determine, based on the first cluster, a persona to use for interacting with the user. For example, if the first cluster indicates that the user is willing to spend time researching the features of an item, the persona can include providing a large amount of details (e.g., technical specifications, features, etc.) about the item. On the other hand, if the first cluster indicates that the user does not want to spend much time researching the item, the persona can include providing a moderate amount of details (e.g., brand, manufacturer, key features, pricing, etc.) about the item.

In one example, assume that the user is querying a pair of trekking poles to acquire. Also assume that the first cluster identified for the user indicates that the user is a beginner hiker who has a set budget range and is not keen on understanding the features/technical details of the trekking poles. The prompt could take the following form:

Write a good_output—a product recommendation where the query is “trekking poles”. good_output must have a price range of example_price_range. good_output needs to include a product that is mostly used for moderate hiking trails that are well-maintained and suitable for hikers of varying experience levels. good_output must be in bullet-point format. good_output must have exactly 3 bullet-points. Each bullet-point must be less than 90 characters. good_output must have no nested bullets. good_output must be catchy and show value-prop. good_output must avoid boring details like numbers.

In this example prompt, the AI system is providing the language model with the following constraints:
A query constraint specifies the query “trekking poles” to which the output clauses should be relevant.
A preference constraint specifies “example_price_range” as a constraint to use in generating the output clauses.
A preference constraint specifies the use of the item (i.e., “mostly be used for moderate hiking trails that are well-maintained and suitable for hikers of varying experience levels”) as a constraint to use in generating the output clauses.
Styling constraints of “must be in bullet-point format . . . must have exactly 3 bullet-points. Each bullet-point must be less than 90 characters . . . must have no nested bullets” specify the format the output clauses must use.
Semantic/Tone Control constraints of “must be catchy and show value-prop. good_output must avoid boring details like numbers” define the tone and content of the output clauses generated using the prompt.

For another example, assume instead that the first cluster identified for the user indicates that the user is an expert hiker who is looking for a pair of trekking poles specifically for backcountry hiking and prefers to know the features/technical details of the trekking poles. The prompt could take the following form:

Write a good_output-a product recommendation where the query is “trekking poles”. good_output needs to include a product that is mostly used for backcountry hiking. The product needs to be made from lightweight yet robust materials like carbon fiber or high-quality aluminum alloys. The product needs to have an extended length range. The product needs to have grips that have a non-slip surface. good_output must be useful and informative, and should include technical details like numbers.

In this example prompt, the AI system is providing the language model with the following constraints:
A query constraint specifies the query “trekking poles” to which the output clauses should be relevant.
A preference constraint specifies the use of the item (i.e., “backcountry hiking”) as a constraint to use in generating the output clauses.
Preference constraints specify the features of the item (i.e., “made from lightweight yet robust materials like carbon fiber or high-quality aluminum alloys,” “extended length range,” and “grips that have a non-slip surface”) as constraints to use in generating the output clauses.
Semantic/Tone Control constraints of “good_output must be useful and informative, and should include technical details like numbers” define the tone and content of the output clauses generated using the prompt.

At 306, the AI system generates, using the prompt, a customized recommendation for the user about the particular item. In some cases, the AI system transmits the prompt to a language model and the prompt causes the language model to generate an output that includes multiple sets of clauses generated according to the query and constraints. The AI system can receive the clauses of the output, and generate multiple candidate customized recommendations that could be provided in response to the user's query. In some implementations, each different candidate customized recommendation includes a different combination of the clauses received from the language model in the output. For example, assume that the output includes 12 different clauses, and that the formatting of the customized recommendations being generated by the AI system each includes space for three different clauses, the AI system could make 220 different candidate customized recommendations using 3 different clauses in each of the candidate customized recommendations (e.g., 12!/(3!(12−3)!)=220). In some situations, the AI system could also create the candidate customized recommendations using a set of different links to online content (e.g., links to web pages discussing a product included in the customized recommendation, links to web pages for acquiring a product included in the customized recommendation, etc.), which can continue to exponentially increase the number of different candidate customized recommendations that the AI system can create using the clauses of the output of the language model.

In some implementations, a candidate customized recommendation can be a single clause obtained from the language model, or a combination of clauses obtained from the language model. The candidate customized recommendation can also include other objects/items, such as links to online resources, scripts that enable various user interactions with the candidate customized recommendation (e.g., placing orders, launching an augmented reality environment, etc.). For example, one or more of the candidate customized recommendations can be generated by combining an output of the language model (e.g., one or more clauses) with a link to a domain (e.g., a home page of example. com) and/or a link to a specific page within the domain (e.g., an item information page of an item described by the clauses).

In some cases, one or more post-processing operations are performed (e.g., using the post-processing apparatus 212) on the candidate customized recommendations. In some implementations, the one or more post processing operations include operations that evaluate one or more characteristics of each given candidate customized recommendation among the multiple different candidate customized recommendations. As noted above, a candidate customized recommendation can be a single clause output from the language model, a combination of clauses, and/or other objects combined with one or more of the clauses output from the language model. As such, the post-processing operations can be performed on any of these candidate customized recommendations, including individual clauses.

Performance of one or more the post-processing operations can be achieved by evaluating how factual a candidate customized recommendation is. In some implementations, the evaluation of how factual a candidate customized recommendation is can be evaluated based on whether the information within the candidate customized recommendation can be verified at one or more specified data sources.

For example, assume that a candidate customized recommendation is describing an item using multiple clauses generated by a language model. In this example, the information about the item can be collected from a set of online resources as described above with respect to operation 302, and used by a language model to generate clauses that are output by the language model. The clauses that are output from the language model may differ from the passages collected in operation 302, for example, to present the information from the passages in a more creative manner. As such, the clauses may not be found verbatim in the set of online resources, but the clauses can still be analyzed to determine whether the information being conveyed by the clauses are consistent with information conveyed by the original passages.

In some implementations, the evaluation of how factual a candidate customized recommendation (e.g., a single clause or combination of clauses) can be performed using grounding scores. For example, for each clause of an output of the language model, a grounding score specifying a likelihood that the clause is factual can he generated based on a level of similarity/difference between the clause and content of a specified online resource or data source.

Using the grounding scores, one or more clauses can be filtered out (e.g., removed from consideration for serving in a candidate customized recommendation). For example, one or more clauses having a grounding score that fails to meet a grounding threshold can be removed from consideration. The grounding threshold is specified to delineate between clauses that are classified as factual and not factual. Using a specified grounding threshold (e.g., minimum score) that is based on a semantic distance (e.g., cosine distance) between a clause and reference content (e.g., at the specified online resource) removes subjectivity of whether information is factual or non-factual, resulting in an objective classification system. When one or more clauses are removed for failing to meet the grounding threshold, those one or more clauses can be removed and replaced with another clause of the output having a grounding score that meets the grounding threshold, or another clause can be evaluated for inclusion in the set of clauses in consideration for inclusion in the candidate customized recommendations.

In some cases, the post-processing operations can include evaluations of other characteristics of the candidate customized recommendations. For example, each given candidate customized recommendation among the multiple candidate customized recommendations can be evaluated with respect to its relevance, completeness, and tone, among other things. The evaluation of the relevance can include evaluating a relevance of the clauses in the given candidate customized recommendation to one or more of the query of the prompt, the constraints of the prompt, search results snippets generated using the query of the prompt, or content of the set of online resources from which the passages were collected (or another specified online data source).

The evaluation of the level of completeness specifies how comprehensively the clauses in the given candidate customized recommendation describe one or more topics. In some cases, the one or more topics can be those topics found in a domain that is linked to by the given candidate digital component. The level of completeness can be higher when the set of clauses (e.g., 3 clauses) in a candidate customized recommendation more fully describe the topics in the domain (e.g., provide more of the details found in the domain), and be lower when the set of clauses less fully describes the topics. For example, an AI agent/machine learning system can compare the semantic space covered (e.g., in a multidimensional semantic space) by the content of the domain with the semantic space covered by the set of clauses. The difference between the semantic space covered (e.g., a mathematical difference or ratio) can be used to arrive at a completeness score for the set of clauses. The difference between the semantic space covered by different sets of content can be determined, for example, by embedding the text of the content (e.g., in vector representations), and determining a distance between (or a level of overlap between) the embeddings. Additionally, or alternatively, the different sets of content can be input to a neural network trained to determine semantic similarity.

In some implementations, the post-processing operations can include evaluating a tone of the clauses of the candidate customized recommendation to determine whether the clauses characterize an item in a positive tone or negative tone. In some implementations, the level of positivity or negativity can be used to generate a tone score, e.g., with positive tone clauses having higher tone scores (e.g., positive scores) than neutral and negative tone clauses, and negative tone clauses having lower tone score (e.g., negative scores) than neutral and positive tone clauses. Neutral tone clauses could be assigned, for example, a score of zero so that they do not contribute positively or negatively to the overall tone of a candidate customized recommendation.

The tone of the clauses can be generated, for example, by submitting the clauses to a language model, and asking the language model whether the tone is positive, neutral, or negative. Additionally, or alternatively, the clauses can be input into a machine learning model that has been trained (e.g., using labeled data) to classify clauses as positive, neutral, or negative in tone. The classifications of the clauses can be used to assign a tone score to each clause, and the overall tone of a candidate customized recommendation can be determined by aggregating (e.g., summing) the tone scores of the individual clauses.

In some cases, each of the multiple candidate customized recommendation can be ranked. In some implementations, the multiple candidate customized recommendations can be ranked based on results of the post-processing operations. The candidate customized recommendations can be ranked based on any of the scores/evaluations discussed above, or a combination of the scores/evaluations discussed above. For example, the post-processing apparatus can sum or average multiple different scores to obtain an aggregate score for a clause, set of clauses, or candidate customized recommendation. In some implementations, the scores can be weighted based on a relative importance of each evaluation to obtain the aggregate score (e.g., weighted average), which can be determined by a system administrator, system architect, and/or machine learning models that evaluate performance feedback of candidate customized recommendations. Using the aggregate scores, the clauses, sets of clauses, or candidate customized recommendations can be ranked (e.g., from highest score to lowest score).

At least one output customized recommendation can be served based on the rankings. The at least one output customized recommendation can be selected, for example, from among the highest ranking candidate customized recommendations, which can be classified as output customized recommendations. More specifically, if one output customized recommendation is to be served, the highest ranked output customized recommendation can be served. If more than one output customized recommendation is going to be served, a set of multiple output customized recommendations that are within the set of highest ranking customized recommendations can be served. Serving the output customized recommendation can include transmitting instructions that cause presentation of the output customized recommendation at a client device.

In some implementations, the user can perform operation(s) on the customized recommendation (e.g., acceptance or rejection) on the client device. The AI system can detect the user operation(s) and retrain the model(s) (e.g., the machine learning model(s) used to identify the first cluster and/or the language model) based on the user operation(s). For example, assuming that the user accepted the customized recommendation (e.g., acquired a product in the customized recommendation), a new training data indicating the user's preference(s) for the item(s) included in the customized recommendation can be generated for retraining the model(s). In addition, the acceptance from the user indicates that the identified cluster is affirmed, so a new training data including a label indicating the identified cluster can be generated and used for retraining the model(s). As another example, assuming that the user rejected the customized recommendation (e.g., returned an item after acquiring the item based on the customized recommendation), a new training data indicating the user's non-preference(s) for the item(s) included in the customized recommendation can be generated for retraining the model(s). In some cases, the user can indicate the reason(s) why they rejected the customized recommendation, such as the item is missing one or more particular features, the price is too high, etc. These reason(s) (which can be transmitted in a message back to the AI system) can be used by the AI system to adjust a cluster for the user and the adjusted cluster can be the label of a new training data used to retrain the model(s). In this manner, actual recommendation data and user responses to the same can be used to iteratively train the models, e.g., in an online manner, thereby continuously facilitating robust and accurate models.

In some instances, the AI system can follow up with the user about an item the user acquires and/or possesses. The responses from the user can be used to retrain the model(s) using operations as described above. For example, if the user acquires an item included in the customized recommendation, the AI system can follow up with the user about the item a certain time period (e.g., several days, weeks, months, etc.) after the acquisition. The AI system can inquire, for example, whether the user likes the item, what specific features the user likes/dislikes, etc. The user responses can be used to retrain the models. For another example, the AI system can transmit, based on context data (e.g., weather data, location data, calendar data, etc.), a prompt to the client device in response to a certain condition, where the prompt asks the user about an item the user possessed. The AI system can inquire the user how they feel about the item, and the user responses can similarly be used to retrain the models.

In some implementations, the AI system can generate customized recommendations based on the items associated with (e.g., possessed, reviewed, recommended, etc.) the user's connections (e.g., family members, friends, social network contacts, etc.). For example, the customized recommendation can be “6 friends rate this 5 stars,”“2 friends recommend a different product instead,” etc. In some cases, the AI system allows the user to view the identities of the connections in the customized recommendation (e.g., the “6 friends” and the “2 friends” in the example customized recommendations above).

In some cases, the AI system can generate a customized recommendation for the user to acquire a particular item for a user's connection. The AI system can obtain the preference(s) of the user's connection and generate a customized recommendation for the user based on the preference(s). For example, the user can send a query to the AI system for gift ideas for sending a gift to the user's connection. The AI system may store the preference(s) of the user's connection, and can use the preference(s) of the user's connection to generate customized recommendations using similar operations as described above.

The user's privacy can be protected using a variety of methods. In one example, the AI system can be configured (e.g., via user settings or by default) not to share the specific item(s) the user possesses. Instead, the AI system can only share the essence of the user's preference(s) (e.g., preference for particular feature(s), brand(s), manufacturer(s), etc.). In some cases, multiple lists can be configured to implement multiple, different levels of data sharing. For example, the user can specify a public list including one or more of the user's connections and a private list including one or more of the user's connections. The user's connections can be obtained from, for example, the user's social network account(s), contact list(s), etc. Some of the user's sensitive data (e.g., the items the user owned) cannot be shared with the connection(s) in the user's public list, whereas such sensitive data can be shared with the connection(s) in the user's private list.

In some examples, the user can request the AI system to perform price tracking for the item(s) included in the customized recommendation(s). In some instances, the user can pre-authorize the AI system to acquire an item included in the customized recommendation at a specific price. For example, the user can specify that if the price of the item satisfies (e.g., meets or below) a price threshold, the AI system can automatically purchase the item. In some cases, the AI system can notify a merchant about an item provided by the merchant for the merchant to, for example, pre-order a certain amount of the item. For example, the AI system can notify the merchant about a quantity of users who have indicated interests (e.g., set price tracking, pre-authorized purchase, etc.) in acquiring the item.

In some implementations, the AI system can generate a prompt when the user is geographically nearby an item included in the customized recommendation. For example, assume that the customized recommendation includes a pair of trekking poles. When the AI system detects, based on the user's location data, that the user is nearby an outdoor store, the AI system can generate a prompt asking if the user wants to see the trekking poles in the outdoor store. In some cases, if the user replies that they want to see the trekking poles, the AI system can automatically generate a notification to the outdoor store for the store staff to prepare the trekking poles for the user to see (e.g., bring the trekking poles to the parking lot, so the user does not need to walk in the store).

In some cases, rather than recommending an item to the user, the customized recommendation can be recommending not to acquire an item. For example, assume that the first cluster identified for the user indicates that the user is a beginner hiker who may not do any backcountry hiking, but the user indicates interests in acquiring an item specifically designed for backcountry hiking. The AI system can generate a customized recommendation for the user not to acquire the item and provide the reasons of the recommendation.

In some implementations, the AI system can calculate a reward (e.g., monetary rewards, points, credits, etc.) for a user who provided a significant review of an item, and send the reward to the user. In some cases, a user (i.e., a reviewer) can submit a review of an item to the AI system. The AI system can analyze the significance of the review based on factor(s) including but not limited to, the authenticity of the review and the impact of the reviewer (e.g., the quantity of social network connections of the reviewer). For one example, the AI system can analyze the authenticity of the review using natural language processing (NLP) techniques, such as sentiment analysis. For example, sentiment analysis can determine the overall sentiment expressed in the review, while aspect-based sentiment analysis can identify sentiments associated with specific aspects or features of the item being reviewed. This analysis can help identify if the review seems genuine or if it contains suspicious patterns. For another example, the AI system can analyze the authenticity of the review using a machine learning model trained to determine the authenticity of reviews.

In some implementations, when the AI system determines that the review of the item is significant, the AI system can embed the description of the item and/or the review of the item in a customized recommendation. For example, the description of the item and/or the review of the item can be a digital component stored in a digital components database (e.g., the digital components database 220), and the AI system can use the digital component to generate a customized recommendation using similar operations discussed above. In some implementations, when the AI system embeds a reviewer's recommended item and/or review in a customized recommendation and sends the customized recommendation to another user, the AI system can detect that the user who receives the customized recommendation accepts the customized recommendation. In such case, the AI system can calculate a reward for the reviewer and send the reward to the reviewer. For example, the AI system can include a hyperlink to the item and/or its review in the customized recommendation. When the AI system detects that the user who receives the customized recommendation clicks on the hyperlink, the AI system can calculate and send a reward to the reviewer. In some cases, a review from a reviewer who has significant impact (e.g., an influencer whose number of social network connections meets or exceeds a predetermined threshold) can carry significant weight. Therefore, the AI system can include the identity of the reviewer in the customized recommendation (e.g., indicating that the customized recommendation is sponsored by the reviewer), if the reviewer has significant impact.

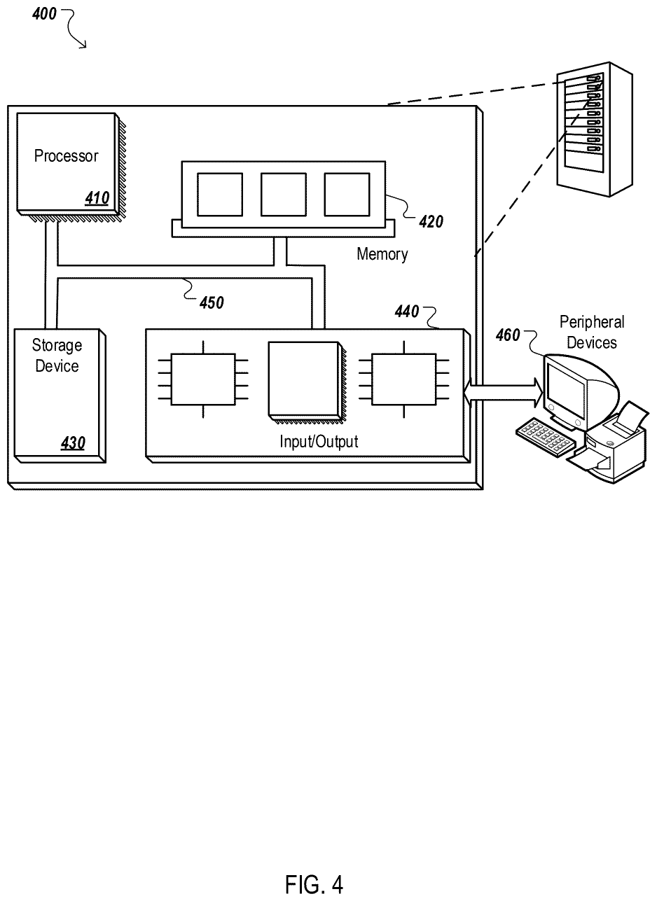

FIG. 4 is a block diagram of an example computer system 400 that can be used to perform described operations, according to an implementation of the present disclosure. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS- 232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
identifying, by an artificial intelligence (AI) system and based on interactions with a user about a particular item, a first cluster from among a plurality of clusters, wherein each of the plurality of clusters indicates one or more preferences about the particular item corresponding to users in the cluster;
generating, by the AI system, a prompt that includes a query and a set of constraints that limit customized recommendations generated by a language model, wherein the set of constraints includes one or more first preferences corresponding to the first cluster; and
generating, by the AI system and using the prompt, a customized recommendation for the user about the particular item.

2. The computer-implemented method of claim 1, wherein generating the prompt comprises inserting at least a part of the one or more first preferences into the prompt as a contextual constraint that limits the customized recommendations created by the language model to subject matter specified in the contextual constraint.

3. The computer-implemented method of claim 1, wherein identifying the first cluster comprises:
generating, by the AI system, one or more questions about preferences of the user for the particular item;
receiving, by the AI system, one or more responses to the one or more questions; and
identifying, by the AI system and based on the one or more responses, the first cluster.

4. The computer-implemented method of claim 3, wherein identifying, by the AI system and based on the one or more responses, the first cluster comprises:
embedding the one or more responses in a multi-dimensional semantic space, wherein each of the plurality of clusters is associated with corresponding sample responses embedded in the multi-dimensional semantic space;
determining a distance between (i) the one or more responses and (ii) sample responses of each cluster of the plurality of clusters; and
identifying the first cluster having the smallest distance among the plurality of clusters.

5. The computer-implemented method of claim 3, wherein identifying, by the AI system and based on the one or more responses, the first cluster comprises inputting the one or more responses to a machine learning model to determine the first cluster.

6. The computer-implemented method of claim 1, wherein identifying the first cluster comprises:
obtaining, by the AI system, one or more images depicting one or more items possessed by the user;
performing, by the AI system, image recognition on the one or more images to identify the one or more items; and
identifying, by the AI system and based on the one or more items, the first cluster.

7. The computer-implemented method of claim 6, wherein identifying, by the AI system and based on the one or more items, the first cluster comprises:
obtaining, by the AI system, user input associated with the one or more items, the user input indicating whether the user characterizes each of the one or more items as positive or negative; and
identifying, by the AI system and based on the user input, the first cluster.

8. The computer-implemented method of claim 7, wherein identifying, by the AI system and based on the user input, the first cluster comprises:
determining a distance between (i) the user input and (ii) sample user inputs of each cluster of the plurality of clusters; and
identifying the first cluster having the smallest distance among the plurality of clusters.

9. The computer-implemented method of claim 7, wherein identifying, by the AI system and based on the user input, the first cluster comprises inputting the user input to a machine learning model to determine the first cluster.

10. The computer-implemented method of claim 1, wherein identifying the first cluster comprises:
obtaining, by the AI system, user utilization associated with one or more items possessed by the user, the user utilization indicating a frequency of use for each of the one or more items;
determining, based on the user utilization, one or more item preferences of the user for the one or more items, wherein a higher user utilization for an item indicates a higher item preference for the item; and
identifying, by the AI system and based on the one or more item preferences, the first cluster.

11. The computer-implemented method of claim 10, wherein identifying, by the AI system and based on the one or more item preferences, the first cluster comprises:
determining a distance between (i) the one or more item preferences and (ii) sample item preferences of each cluster of the plurality of clusters; and
identifying the first cluster having the smallest distance among the plurality of clusters.

12. The computer-implemented method of claim 10, wherein identifying, by the AI system and based on the one or more item preferences, the first cluster comprises inputting the one or more item preferences to a machine learning model to determine the first cluster.

13. The computer-implemented method of claim 10, wherein determining, based on the user utilization, one or more item preferences of the user for the one or more items comprises:
determining whether a first user utilization associated with a first item satisfies a predetermined threshold; and
in response to determining that the first user utilization satisfies the predetermined threshold, determining that a first item preference for the first item is high; or
in response to determining that the first user utilization does not satisfy the predetermined threshold, determining that a first item preference for the first item is low.

14. The computer-implemented method of claim 1, wherein identifying the first cluster comprises:
obtaining, by the AI system, contents from one or more social network accounts associated with the user; and
identifying, by the AI system and based on the obtained contents, the first cluster.

15. The computer-implemented method of claim 14, wherein the obtained contents indicate whether the user characterizes each of one or more items as positive or negative, and wherein the method comprises:
performing sentiment analysis on the obtained contents to generate one or more item preferences of the user for the one or more items; and
inputting the one or more item preferences to a machine learning model to determine the first cluster.

16. The computer-implemented method of claim 1, wherein the one or more preferences about the particular item comprise at least one of a budget level for acquiring the particular item, a quality level of the particular item, one or more preferred features of the particular item, or a preferred amount of time for researching the particular item.

17. The computer-implemented method of claim 1, wherein generating, by the AI system and using the prompt, the customized recommendation for the user about the particular item comprises:
generating, using the query and the set of constraints, a plurality of clauses; and
generating, based on the plurality of clauses, the customized recommendation.

18. One or more non-transitory computer readable medium storing instructions, that when executed by a computer-implemented artificial intelligence (AI) system, causes the computer-implemented AI system to perform operations comprising:
identifying, by an artificial intelligence (AI) system and based on interactions with a user about a particular item, a first cluster from among a plurality of clusters, wherein each of the plurality of clusters indicates one or more preferences about the particular item corresponding to users in the cluster;
generating, by the AI system, a prompt that includes a query and a set of constraints that limit customized recommendations generated by a language model, wherein the set of constraints includes one or more first preferences corresponding to the first cluster; and
generating, by the AI system and using the prompt, a customized recommendation for the user about the particular item.

19. A computer-implemented artificial intelligence (AI) system comprising:
one or more processors; and
one or more storage devices storing instructions that, when executed by the one or more processors, cause the one or more processors to perform operations comprising:
identifying, by an artificial intelligence (AI) system and based on interactions with a user about a particular item, a first cluster from among a plurality of clusters, wherein each of the plurality of clusters indicates one or more preferences about the particular item corresponding to users in the cluster;
generating, by the AI system, a prompt that includes a query and a set of constraints that limit customized recommendations generated by a language model, wherein the set of constraints includes one or more first preferences corresponding to the first cluster; and
generating, by the AI system and using the prompt, a customized recommendation for the user about the particular item.

20. The system of claim 19, wherein generating the prompt comprises inserting at least a part of the one or more first preferences into the prompt as a contextual constraint that limits the customized recommendations created by the language model to subject matter specified in the contextual constraint.
